(19) United States
(12) Patent Application Publication
(10) Pub. No.: US 2011/0281199 A1
(43) Pub. Date: Nov. 17, 2011

(54) ELECTRODE FOR FUEL CELL, METHOD OF PREPARING THE SAME, MEMBRANE ELECTRODE ASSEMBLY AND FUEL CELL INCLUDING THE SAME

(75) Inventors: Takezawa MANABU, Osaka (JP); Aihara Yuichi, Osaka (JP)

(73) Assignee: Samsung Electronics Co., Ltd., Suwon-si (JP)

(21) Appl. No.: 13/105,083

(22) Filed: May 11, 2011

(30) Foreign Application Priority Data
May 11, 2010 (JP) 2010-109408
Feb. 22, 2011 (KR) 10-2011-0015568

(51) Int. Cl. H01M 8/10; H01M 4/96; H01M 4/92; H01M 4/90; B05D 5/12; H01M 4/86

(52) U.S. Cl. 429/483; 427/115; 429/482; 429/523; 429/524; 429/525; 429/526; 429/527; 429/530; 429/531; 429/532

(57) ABSTRACT

An electrode for a fuel cell with an operating temperature of about 100° C. or more. The electrode has an electrode catalyst layer that includes an electrode catalyst with a conductive carrier and catalyst particles supported on the conductive carrier. The electrode catalyst includes an acid impregnated electrode catalyst in which the conductive carrier is impregnated with an acid component having proton conductivity by a heat treatment with the acid component in advance, and a non-impregnated electrode catalyst. The acid impregnated electrode catalyst and the non-impregnated electrode catalyst are uniformly distributed in the electrode catalyst layer.

### CROSS-REFERENCE TO RELATED APPLICATIONS

This application claims the benefit of Japanese Patent Application No. 2010-109408, filed on May 11, 2010 in the Japan Patent Office, and Korean Patent Application No. 10-2011-0015568, filed on Feb. 22, 2011 in the Korean Intellectual Property Office, the disclosures of which are incorporated herein in their entirety by reference.

### BACKGROUND

1. Field

Aspects of the present disclosure relate to an electrode for a fuel cell, a method of preparing the same, a membrane electrode assembly and a fuel cell which includes the electrode for a fuel cell.

2. Description of the Related Art

Fuel cells may include a fluorinated electrolyte membrane represented by a perfluorosulfonic acid membrane, such as NAFION® (DuPont Corp.). When such an electrolyte membrane is used, a so-called ion cluster structure is formed by phase separation of the hydrophobic main chain and hydrophilic side chain. As a proton transport mechanism, it has been known that high proton conductivity may be achieved by promoting dissociation of a sulfonic acid group by allowing a large amount of water molecules being admitted into the electrolyte membrane structure, and at the same time, by using the high mobility of water molecules.

However, since the fuel cell as described above has a limited operating temperature of about 70° C. to about 80° C. due to water-dependent proton conduction and also requires a humidifier as an auxiliary device, a moisture control system becomes complicated. Also, the operating temperature is a major limitation of such a fuel cell system. As a result, a catalyst may suffer poisoning due to carbon monoxide generated as a by-product during manufacturing of hydrogen gas and a carbon monoxide removing apparatus is also indispensible, making the overall fuel cell system very expensive.

In consideration of these limitations, the development of an electrolyte membrane is being actively conducted in order to create fuel cells capable of producing clean energy in which proton conduction is possible under a non-humidified or low-humidified condition such that a fuel cell is operable at high temperatures of about 100° C. or more. Thus, if an electrolyte membrane is provided enabling protons to be conducted in a high-temperature environment where proton conduction does not depend on water, a fuel cell system may be simplified, and therefore, wide spread use may be made of a fuel cell system for residential cogeneration or automobile applications. For example, one of these fuel cells is a phosphoric acid fuel cell (PAFC), and various such cells have been developed (e.g., see Japan Published Patent No. H10-144324 and Japan Published Patent No. 2001-52718).

Recently, many proposals have been suggested relating to a polymer electrolyte fuel cell (PEFC) operating at about 100° C. or more. In general, since catalyst activation is improved in the case where power generation is conducted at about 100° C. or more, it is suggested that degree of poisoning due to carbon monoxide may be reduced. Further, it is thought that the lifetime of a fuel cell may be extended. However, since water molecules are unable to stably exist in a medium-temperature operation of about 150° C., fuel cells employing electrolytes which do not depend upon an aqueous medium for proton conduction, such as phosphoric acid impregnated polybenzimidazole, e.g., as described in U.S. Pat. No. 5,525,436, have been suggested. It is thought that the foregoing fuel cell can generate power even in a medium temperature range of about 150° C.

### SUMMARY

Since a fuel cell employing a phosphoric acid impregnated polybenzimidazole-based electrolyte uses phosphoric acid as a proton conductor, it is required that phosphoric acid play the role of the proton conductor both in the electrolyte and in the electrode catalyst layer in order to improve power generation characteristics. As a result, there is a limitation in that power generation performance depends on the dispersion degree and the amount of phosphoric acid in an electrode catalyst layer.

Also, in a fuel cell using a phosphoric acid impregnated electrolyte membrane, since over prolonged power generation phosphoric acid is leached from the electrolyte membrane and flows out externally, there is a limitation in a fuel cell's exhibiting sufficient power generation performance over prolonged time. Further, since the phosphoric acid outflow process from the leached phosphoric acid in the electrolyte membrane blocks openings for gas diffusion in the electrolyte catalyst layer, there is a limitation in that an electrode reaction is not sufficiently performed.

Aspects of the present invention provide an electrode for a fuel cell, the electrode being able to stably maintain its power generation characteristics from the initial stage of operation under a high temperature operating condition, a method of preparing the electrode, and a fuel cell including the electrode.

An aspect of the present invention provides an electrode for a fuel cell including an electrode catalyst layer, wherein the electrode catalyst layer includes an electrode catalyst including a conductive carrier and catalyst particles supported on the conductive carrier, and the electrode catalyst includes an acid impregnated electrode catalyst in which the conductive carrier is impregnated with an acid component having proton conductivity and a non-impregnated electrode catalyst in which the conductive carrier is not impregnated with the acid component.

The electrode catalyst layer may have a mixing ratio in which the ratio of the weight of the acid impregnated electrode catalyst to the weight of the non-impregnated electrode catalyst ranges from about 5:95 to about 95:5, during the forming of the electrode catalyst layer. Since the electrode catalyst layer is composed of the acid impregnated electrode catalyst and the non-impregnated electrode catalyst that are mixed in the above ratio, a water-soluble free acid, which is leached from a polymer electrolyte membrane, may be appropriately adsorbed. As a result, a phenomenon in which openings for gas diffusion paths may be blocked may be prevented. Also, the durability of the electrode catalyst layer may be improved.

The conductive carrier may be a carbonaceous material.

The catalyst particles may include one or more metals or alloys selected from the group consisting of platinum (Pt), gold (Au), palladium (Pd), rhodium (Rh), iridium (Ir), ruthenium (Ru), cobalt (Co), iron (Fe), lead (Pb), manganese (Mn), chromium (Cr), gallium (Ga), tin (Sn), molybdenum (Mo), and vanadium (V). Specifically, the catalyst particles may be platinum (Pt) alone; a mixture or an alloy including platinum and one or more metals selected from the group consisting of gold (Au), palladium (Pd), rhodium (Rh), iridium (Ir), ruthenium (Ru), cobalt (Co), iron (Fe), lead (Pb), manganese (Mn), chromium (Cr), gallium (Ga), tin (Sn), molybdenum (Mo), and vanadium (V); or a mixture or an alloy of two or more metals selected from the group consisting of gold (Au), palladium (Pd), rhodium (Rh), iridium (Ir), ruthenium (Ru), cobalt (Co), iron (Fe), lead (Pb), manganese (Mn), chromium (Cr), gallium (Ga), tin (Sn), molybdenum (Mo), and vanadium (V).

The acid component may be an aqueous solution of at least one or more acids selected from the group consisting of phosphoric acid, phosphoric acid derivatives, phosphonic acid, phosphonic acid derivatives, phosphinic acid, phosphinic acid derivatives, sulfuric acid, sulfuric acid derivatives, sulfonic acid, and sulfonic acid derivatives.

The electrode catalyst layer may further include one or more hydrophobic binder resins selected from the group consisting of polytetrafluoroethylene (PTFE), poly(vinylidene fluoride) (PVDF), tetrafluoroethylene-hexafluoropropylene copolymer, polychlorotrifluoroethylene (PCTFE), tetrafluoroethylene-ethylene copolymer (ETFE), tetrafluoroethylene-perfluoroalkylvinyl ether copolymer, styrene butadiene rubber (SBR), and polyurethane.

The conductive carrier may be a porous particle having a Brunauer-Emmett-Teller (BET) surface area of about 50 to about 1500 m²/g.

When the foregoing conductive carrier, catalyst particles, acid component, and hydrophobic binder resin are used, the characteristics of an electrode for a fuel cell according to an aspect of the present invention may be improved. Further, power generation characteristics of a fuel cell, which has an electrode for a fuel cell according to an aspect of the present invention, may be improved.

Another aspect of the present invention provides a method of preparing an electrode for a fuel cell including: coating a composition for an electrode catalyst layer on a substrate, which composition includes an acid impregnated electrode catalyst in which a conductive carrier is impregnated with an acid component having proton conductivity and a non-impregnated electrode catalyst in which the conductive carrier is not impregnated with the acid component; and drying the coated composition for an electrode catalyst layer to form an electrode catalyst layer.

The composition for an electrode catalyst layer may have a mixing ratio in which the ratio of the weight of the acid impregnated electrode catalyst to the weight of the acid non-impregnated electrode catalyst ranges from about 5:95 to about 95:5.

The acid impregnated electrode catalyst may be formed by a method including dispersing the non-impregnated electrode catalyst in the acid component and performing a heat treatment, for example a vacuum heat treatment. For example, the acid impregnated electrode catalyst may be formed by a method including: after dispersing the acid non-impregnated electrode catalyst in the acid component, impregnating the acid component into the pores of the conductive carrier of the non-impregnated electrode catalyst by maintaining the contact conditions for the above dispersed non-impregnated electrode catalyst to obtain the acid impregnated electrode catalyst; impregnating the acid component into the pores of the acid impregnated electrode catalyst in higher concentration by a heat treatment, for example a vacuum heat treatment of the acid impregnated electrode catalyst; and washing and drying the acid impregnated electrode catalyst.

The vacuum heat treatment may be performed at the temperature of about 100° C. to about 150° C. The heat treatment is performed at the above temperature range under reduced pressure lower than atmospheric pressure such that acid may be effectively impregnated into the pores of the conductive carrier without changing the properties of the acid. The acid may be an aqueous solution having a concentration of about 85 wt % or less. Since the aqueous acid solution has appropriate viscosity by employing the aqueous acid solution with the above concentration, the acid impregnation treatment may be effectively performed.

Another aspect of the present invention provides a membrane electrode assembly (MEA) for a fuel cell including: a cathode and an anode disposed to face each other; and a solid electrolyte membrane disposed between the cathode and the anode, wherein the solid electrolyte membrane may include an acid-doped basic polymer, and at least one of the cathode and the anode is an electrode for a fuel cell according to another aspect of the present invention.

Another aspect of the present invention provides a fuel cell including a membrane electrode assembly including an electrode for a fuel cell according to another aspect of the present invention. For example, the fuel cell may be a polymer electrolyte fuel cell in which a fuel gas is supplied to the anode and an oxidant gas is supplied to the cathode at the same time, and an operating temperature is about 100° C. or more.

According to the foregoing configurations, since the acid component, such as the phosphoric acid as a proton path, is effectively impregnated in the pores of the conductive carrier of the acid impregnated electrode catalyst, improvement of fuel cell power generation characteristics may be promoted due to an increase in catalyst reaction area. Reduction of aging (conditioning) time for activating initial power generation may also be promoted. Also, since the electrode catalyst layer has uniformly distributed acid impregnated and non-impregnated electrode catalysts, acids that are leached from the polymer electrolyte membrane over time may be trapped. Further, openings for gas diffusion in the electrode catalyst layer may be maintained. As a result, durability may be improved as well as deterioration of the power generation characteristics is reduced.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view illustrating a structure of an electrode for a fuel cell according to an embodiment of the present invention;

FIG. 2 is a cross-sectional view illustrating a structure of a membrane electrode assembly including an electrode for a fuel cell according to another embodiment of the present invention;

FIG. 3 is a graph showing power generation characteristics of a single cell according to Example 1 and Comparative Example 1 of the present invention; and

FIG. 4 is a graph showing changes in power generation characteristics of a single cell over time according to Example 1 and Comparative Examples 1-2 of the present invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Electrode for a Fuel Cell

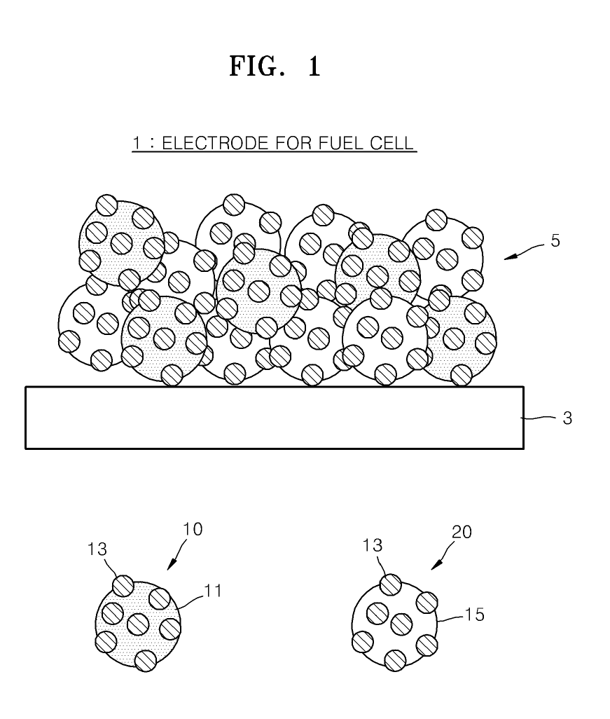

First, a structure of an electrode for a fuel cell according to an embodiment of the present invention will be described with reference to FIG. 1. FIG. 1 is a schematic view illustrating a structure of an electrode for a fuel cell according to the present embodiment. An electrode 1 for a fuel cell according to the present embodiment has a polymer electrolyte membrane 3 and an electrode catalyst layer 5 as shown in FIG. 1.

Polymer Electrolyte Membrane 3

First, the polymer electrolyte membrane 3 according to the present embodiment will be described. The polymer electrolyte membrane 3 includes a basic polymer doped with an acid component and supports the electrode catalyst layer 5 described later.

Although the basic polymer is not particularly limited, aromatic-based engineering plastic is desirable when considering the compatibility between an acid doping to the basic polymer and a polar solvent, a process of forming a membrane, heat resistance, etc. The aromatic engineering plastic is not limited as long as it has an aromatic property. For example, the aromatic engineering plastic may include polybenzimidazole, poly(pyridine), poly(pyrimidine), polyimidazole, polybenzothiazole, polybenzoxazole, polyoxazole, polyquinoline, polyquinoxaline, polythiadiazole, poly(tetradipyrene), polythiazole, polyvinylpyridine, polyvinylimidazole, polyetheretherketone, polyphenylene oxide, aromatic polyimide, aromatic polyamide, polycarbonate, polyethylene terephthalate, polyarylate, and polyimide, etc.

The polymer electrolyte membrane 3 is doped with an acid component, e.g., water-soluble free acid. The water-soluble free acid according to the present embodiment is not particularly limited and may include various acids such as phosphoric acid, phosphonic acid, phosphinic acid, sulfuric acid, methylsulfonic acid, trifluoromethyl sulfonic acid, or trifluoromethane sulfonyl amide sulfonic acid. It is particularly desirable from the thermal stability point of view that the water-soluble free acid according to the present embodiment may be an acidic inorganophosphorus compound or an acidic organophosphorus compound.

For example, the acidic inorganophosphorus compound may include phosphoric acid, polyphosphoric acid, phosphonic acid, phosphinic acid, etc. The acidic organophosphorus compound may include, for example, an alkyl phosphoric acid (an alkyl ester of phosphoric acid) represented by methyl phosphoric acid, ethyl phosphoric acid, butyl phosphoric acid or the like, an alkyl or alkenyl phosphonic acid represented by vinyl phosphonic acid, allyl phosphonic acid, methyl phosphonic acid, ethyl phosphonic acid or the like, and an aryl phosphonic acid such as phenyl phosphonic acid, (naphthalen-1-yloxy)phosphonic acid.

A mixture of free acid and Lewis base or a mixture of free acid and organic salt may be used as the water-soluble free acid. For example, the Lewis base, which may be used by mixing with the free acid, may include, azole-based compounds such as imidazole, triazole, benzimidazole, and benzotriazole, nitrogen-containing six-membered heterocyclic compounds such as pyridine, pyridazine, pyrimidine, pyrazine, and triazine, condensed polycyclic nitrogen-containing heterocyclic compounds such as quinoline, quinoxaline, indole, and phenazine, and nucleobases such as purine, uracil, thymine, cytosine, adenine, and guanine, etc.

Also, the organic salt, which may be used by mixing with the free acid, may include, for example, a neutral salt consisting of an organic compound cation and an oxoacid anion. In general, the organic compound cation may include cations of heterocyclic compounds, particularly cations of 3-6 membered heterocyclic compounds including 1-5 heteroatoms, and more particularly cations of 3-6 membered heterocyclic compounds including 1-5 nitrogen atoms as heteroatoms, and specifically, may include imidazolium cation, pyrrolidinium cation, piperidinium cation, and pyridinium cation, etc. Also, a linear quaternary ammonium cation, linear quaternary phosphonium cation or the like may be used.

The polymer electrolyte membrane 3, which includes the polymer electrolyte and the water-soluble free acid as described above, may be prepared by known methods. The following is a brief description of a method of preparing a polymer electrolyte membrane 3. First, a polymer electrolyte solution is prepared using a known solvent, and the prepared solution is cast to form a membrane on a substrate using a known coating method and then dried. Thereafter, the formed polymer electrolyte membrane is immersed in a solution including water-soluble free acid such that the membrane doped with the water-soluble free acid, which is swollen by the free acid, is obtained. Therefore, the polymer electrolyte membrane 3 according to the present embodiment may be prepared.

Besides the above method, the polymer electrolyte membrane 3, for example, may also be prepared using the following method. That is, a solution including a polymer electrolyte and free acid is prepared using a known solvent, and the prepared solution is cast on a substrate using a known coating method. Thereafter, the polymer electrolyte membrane 3 according to the present embodiment may be prepared by drying the cast polymer electrolyte membrane on the substrate.

Also, a doping amount of the water-soluble free acid into the polymer electrolyte may be appropriately set according to the performance required for the polymer electrolyte membrane.

Electrode Catalyst Layer 5

The electrode catalyst layer 5 according to the present embodiment will be described in detail. The electrode catalyst layer 5 according to the present embodiment, as shown in FIG. 1, is a layer supported by the polymer electrolyte membrane 3. An acid impregnated electrode catalyst 20, in which pretreatment by an acid to be described later is performed, and a non-impregnated electrode catalyst, in which no pretreatment is performed, are uniformly dispersed in the electrode catalyst layer 5. The difference between the acid impregnated electrode catalyst (hereinafter, sometimes referred to as the “doped catalyst 20”) and the non-impregnated electrode catalyst 10 (hereinafter, sometimes referred to as the “undoped catalyst 10”), which are included in the electrode catalyst layer 5 according to the present embodiment, is the presence of the pretreatment by the acid to be described later.

The undoped electrode catalyst 10 according to the present embodiment is composed of a conductive carrier 11 and catalyst particles 13 supported thereon. This electrode catalyst is an undoped catalyst 10 according to the present embodiment. Also, if the undoped catalyst 10 is pretreated by an acid as described in the following, it becomes a doped catalyst 20.

That is, the undoped catalyst 10, as shown in the left lower portion of FIG. 1, is composed of a conductive carrier 11 and an electrode catalyst 13 supported on the conductive carrier 11. The doped catalyst 20, as shown in the right lower portion of FIG. 1, is composed of a conductive carrier 15 in which an acid is impregnated by the pretreatment and catalyst particles 13 supported on the conductive carrier 15 in which the pretreatment is performed.

The conductive carrier 11 or 15 according to the present embodiment is not particularly limited as long as it has conductivity. For example, a porous body may be used, in which a main component is a carbonaceous material having conductivity. The carbonaceous material may include carbon black such as furnace black, ketjen black, and acetylene black; activated carbon; and graphite, etc.

Herein, a specific surface area of the conductive carrier may be appropriately selected according to the characteristics of the polymer electrolyte membrane 3 according to this present embodiment. For example, when the free acid content included in the polymer electrolyte membrane 3 is relatively low (hereinafter, sometimes referred to as “low doping state”), the specific surface area of the conductive carrier 15 may be low. Also, when the free acid content included in the polymer electrolyte membrane 3 is relatively high (hereinafter, sometimes referred to as “high doping state”), it is desirable for the conductive carrier 15 to have a large specific surface area in order to trap the acid leached from the polymer electrolyte membrane in the high doping state over time. Also, from the viewpoint of oxidation resistance of the carbonaceous material as the conductive carrier 15, it is desirable to use graphitized carbon blacks rather than general carbon blacks as a catalyst carrier in a solid polymer type fuel cell operated at high temperatures.

A Brunauer-Emmett-Teller (BET) specific surface area may be used as the foregoing surface area, and, for example, the BET specific surface area of the conductive carrier according to the present embodiment may be about 50-1500 m²/g. The BET specific surface area may be measured using known methods such as an adsorption method, in which molecules with a known adsorption area of occupancy are allowed to be adsorbed on surfaces of particles at low temperatures and the specific surface area is measured from an adsorption amount thereof, a heat of wetting method, a permeation method, and a diffusion rate method, etc. Since a carbonaceous carrier having so much developed graphite structure has a small specific surface area, water repellency becomes high. Therefore, it is not desirable because it is difficult for the acid component to be absorbed and absorption of the acid component also takes time.

Catalyst particles 13 supported on the conductive carrier 11 are not particularly limited. For example, platinum or an alloy including platinum and at least one or more of non-precious metals may be used. The alloy including platinum and at least one or more of non-precious metals may include a Pt—Co alloy containing platinum and cobalt, a Pt—Ru alloy containing platinum and ruthenium, and Pt—Fe alloy containing platinum and iron, etc. Also, in addition to platinum or the alloy including platinum and at least one or more of non-precious metals, gold, lead, iron, manganese, cobalt, chromium, gallium, vanadium, tungsten, ruthenium, iridium, palladium, rhodium, or an alloy having any two or more thereof may be used.

Herein, a supported amount of the catalyst particles 13, which are supported on the conductive carrier 11 according to the present embodiment, may be appropriately determined according to the performance required for the electrode for a fuel cell according to the present embodiment. A method of supporting the catalyst particles 13 on the conductive carrier 11 may be a known method.

In the present embodiment, the conductive carrier 11 of the undoped catalyst 10 is impregnated with acid by pretreatment using acid (e.g., vacuum heat treatment using acid) on the undoped electrode catalyst 10 composed of the conductive carrier 11 and the catalyst particles 13 as described above.

The acid used for the vacuum heat treatment may be phosphoric acid and derivatives thereof, phosphonic acid and derivatives thereof, phosphinic acid and derivatives thereof, sulfuric acid and derivatives thereof, and sulfonic acid and derivatives thereof, e.g., methylsulfonic acid, trifluoromethyl sulfonic acid, and trifluoromethane sulfonyl amide sulfonic acid. In the vacuum heat treatment according to the present embodiment, one of the foregoing acids or more combinations of the foregoing acids may be used. From the viewpoint of thermal stability, an acidic inorganophosphorus compound or an acidic organophosphorus compound is particularly desirable to be used among the foregoing acids.

For example, the acidic inorganophosphorus compound may include phosphoric acid (orthophosphoric acid), polyphosphoric acid (condensed phosphoric acid), phosphonic acid, and phosphinic acid, etc. For example, the acidic organophosphorus compound may include an alkyl phosphoric acid (an alkyl ester of phosphoric acid) represented by methyl phosphoric acid, ethyl phosphoric acid, butyl phosphoric acid or the like, an alkyl or alkenyl phosphonic acid represented by vinyl phosphonic acid, allyl phosphonic acid, methyl phosphonic acid, ethyl phosphonic acid or the like, and an aryl phosphonic acid such as phenyl phosphonic acid, (naphthalen-1-yloxy)phosphonic acid. Among these phosphorous compounds, the acid used for the vacuum heat treatment may be one or more acids selected from the group consisting of orthophosphoric acid, polyphosphoric acid, an alkyl phosphoric acid, and an alkyl phosphonic acid. The alkyl phosphoric acid may be specifically C1-C20 alkyl phosphoric acids, and the alkyl phosphonic acid may be specifically C1-C20 alkyl phosphonic acids.

In the vacuum heat treatment using acid, electrode catalyst (the undoped catalyst 10) is first dispersed in a solution (e.g., aqueous solution) containing the foregoing acid, and the solution is maintained in a vacuum apparatus for a predetermined time after stirring. Air existing in the pores of a conductive carrier 11 is forced out according to the above process and the acid is impregnated in the pores. Thereafter, heat treatment on the electrode catalyst 20 impregnated with acid is performed, for example, in the temperature range of about 100-150° C. After the heat treatment, the doped catalyst 20 according to the present embodiment may be obtained by washing, filtering, and drying the electrode catalyst. Water molecules in an acid solution, which is impregnated into the pores, are extracted by the heat treatment at the temperature of about 100° C. or more, and impregnation of the acid is possible after the extracting of the water molecules. Accordingly, the foregoing acids will be impregnated into the pores of the conductive carrier at high density.

Also, when the heat treatment temperature is less than about 100° C., it is difficult to remove the water molecules from the acid solution. When the heat treatment temperature is more than about 150° C., properties of the impregnated acids (e.g., phosphoric acid, etc.) may begin to change.

A concentration of the acid solution (e.g., aqueous solution of phosphoric acid) used for the vacuum heat treatment may be about 85 wt % or less. By using the acid solution having the above concentration, the acid solution has a relatively low viscosity appropriate for the vacuum heat treatment such that acid may be impregnated effectively.

Herein, an amount (i.e., doping amount) of the acid impregnated into the undoped catalyst 10 may be appropriately determined in order to obtain the performance required for the electrode for a fuel cell according to the present embodiment. Also, the doping amount may be controlled by properly adjusting the acid solution concentration, solution quantity, catalyst species (specific surface area of a conductive carrier), heat treatment temperature, treatment time, etc. The doping amount may be measured using various analysis methods, and may be quantified using an inductively coupled plasma-atomic emission spectrometry (ICP-AES) method.

In the present embodiment, the electrode catalyst layer 5 is prepared by combining and using the doped catalyst 20 thus prepared and the undoped catalyst 10 which has not been subjected to the vacuum heat treatment with an acid. At this time, the two catalysts are mixed to obtain a weight ratio of the doped catalyst 20 to the undoped catalyst 10 to be in the range of about 5:95 to about 95:5, and the electrode catalyst layer 5 is formed in such a manner that the two catalysts are uniformly dispersed. Specifically, the weight ratio of the doped catalyst 20 to the undoped catalyst 10 may be in the range of about 80:20 to about 95:5.

Acid distribution, which is a proton path (proton conduction path) in the electrode catalyst layer 5, may be uniformly obtained by forming the electrode catalyst layer 5 to have an initial mixed ratio of the doped catalyst 20 to the undoped catalyst 10 in the foregoing range. Further, the characteristics of a fuel cell using the foregoing electrode may be improved. Reduction of conditioning (aging) time during initial operation, which is conducted to stabilize the acid distribution in the electrode catalyst layer 5, may also be promoted. Since the undoped catalyst 10, which may impregnate the acid (water-soluble free acid) leached from the polymer electrolyte membrane 3 into the pores of the conductive carrier 11, exists in the electrode catalyst layer 5, openings for gas diffusion may be secured by trapping the acid leached from the polymer electrolyte membrane 3 as well as durability of the electrode may be improved. As a result, the electrode for a fuel cell having the foregoing electrode catalyst layer 5 may promote improvements in the characteristics and durability of a fuel cell.

When the weight ratio of the doped catalyst 20 to the undoped catalyst 10 is less than about 5 and when the weight ratio of the doped catalyst 20 to the undoped catalyst 10 is more than about 95, the foregoing effects may be obtained but the effects are not satisfactory. When the weight ratio of the doped catalyst 20 to the undoped catalyst 10 is in the range of about 80 to about 95, the foregoing characteristics and durability of a fuel cell may be further improved.

In the present embodiment, the electrode catalyst layer 5 is formed on the polymer electrolyte membrane 3 by binding the doped and undoped electrode catalysts 20 and 10 mixed at the foregoing ratio range on the polymer electrolyte membrane 3 using a binder. The binder content may be in the range of about 5 wt % to about 500 wt %, for example, about 10 wt % to about 250 wt %, and specifically, about 20 wt % to about 200 wt %, based on the total weight of the undoped catalyst 10 and the doped catalyst 20. If the binder content is in the above ranges, the balance between mechanical and power generation characteristics of the electrode catalyst layer may be promoted.

For example, a fluororesin having excellent heat resistance may be used as a binder for forming the electrode catalyst layer 5. When the fluororesin is used as the binder, a fluororesin with melting point of about 400° C. or less is desirable. A fluororesin having excellent hydrophobic and heat resistant properties, such as polytetrafluoroethylene, tetrafluoroethylene-perfluoroalkylvinyl ether copolymer, polyvinylidenefluoride, tetrafluoroethylene-hexafluoropropylene copolymer polychlorotrifluoroethylene (PCTFE), and tetrafluoroethylene-ethylene copolymer (ETFE), may be used as the foregoing fluororesin. Since addition of the hydrophobic binder may prevent excessive wetting of the catalyst layer by water which is generated by accompanying with power generation reaction, obstruction of diffusion of fuel gas and oxygen in fuel and oxygen electrodes may be prevented.

A conductive material may also be added in the electrode catalyst layer 5 according to the present embodiment. Any electroconductive material may be used as the conductive material, and the conductive material may include various metals or carbonaceous materials, etc. For example, the carbonaceous material may include carbon black such as acetylene black, activated carbon, and graphite, etc., and these carbonaceous materials and various metals may be used alone or in combination.

As the above, the electrode catalyst layer 5 according to the present embodiment was described with reference to FIG. 1. FIG. 1 schematically illustrates only a portion of the electrode catalyst layer 5, and the undoped catalyst 10 and the doped catalyst 20 are uniformly distributed in the overall electrode catalyst layer 5.

Method of Preparing Electrode Catalyst Layer 5

A method of preparing an electrode catalyst layer according to the present embodiment will be described below. The method of preparing the electrode catalyst layer according to the present embodiment includes (1) preparing an undoped catalyst, (2) vacuum heat treatment by means of an acid (i.e., preparing a doped catalyst 20), (3) forming a membrane, and (4) drying.

(1) Preparing an Undoped Catalyst 10

This is a process of preparing an undoped catalyst 10 by supporting catalyst particles 13 on a conductive carrier using the foregoing conductive carrier 11 and catalyst particles 13. Since supporting of catalyst particles 13 on a conductive carrier 11 is well-known, a detailed description will not be provided herein.

(2) Vacuum Heat Treatment By Means of an Acid

Using the undoped catalyst 10 prepared by the process (1), this is a process of preparing a doped catalyst 20 by impregnating the conductive carrier 11 of the undoped catalyst 10 with the foregoing acid component (e.g., phosphoric acid, etc.). Hereinafter, the case where phosphoric acid is impregnated into pores of the conductive carrier 11 will be described as an example.

First, a predetermined amount of the undoped catalyst 10, which is prepared in the process (1), is weighed and dispersed in a phosphoric acid solution having a concentration of about 85 wt % or less, and stirred using a mechanical or magnetic stirrer, etc. Of course, a device used for stirring is not limited to the mechanical or magnetic stirrer, and other devices may be used if they are able to sufficiently mix the undoped catalyst 10 in the aqueous solution of phosphoric acid. Also, when air bubbles are generated by stirring, the mixture being stirred may be defoamed by vacuum defoaming or centrifugal defoaming.

After the stirring process as described above, a slurry thus obtained is placed in a vacuum device and phosphoric acid is impregnated into the pores of the conductive carrier 15 by maintaining the slurry for a predetermined time (e.g., about 1 hour). Thereafter, heat treatment is performed on the electrode catalyst impregnated with phosphoric acid in the range of about 100-150° C. Accordingly, water molecules existing in the pores of the conductive carrier are displaced and phosphoric acid is impregnated into the pores at high density. Subsequently, after washing and filtering the electrode catalyst impregnated with the phosphoric acid, the electrode catalyst 20 impregnated with the phosphoric acid (i.e., doped catalyst 20) is obtained by drying.

(3) Forming a Membrane

First, the doped catalyst prepared by the process (2) and the undoped catalyst prepared by the process (1) are mixed to obtain a predetermined weight ratio. That is, each of the foregoing two electrode catalysts are mixed to obtain the weight ratio of the doped catalyst 20 to the undoped catalyst 10 to range from about 5:95 to about 95:5, for example, from about 80:20 to about 95:5.

Next, after dispersing the mixture of the electrode catalysts 13 thus obtained in a binder solution, an electrode catalyst in a paste form is prepared by stirring. Also, it is desirable that a solvent used for dissolving the binder is determined by considering the compatibility between the electrode catalyst and binder solution.

Continuously, an electrode catalyst layer is formed by casting the electrode catalyst paste on an electrode supporting substrate using a known coating method. For example, the electrode catalyst paste may be cast on the substrate using a die coater, a comma coater, a doctor blade, or an application roll, etc.

(4) Drying Process

This is a process of drying the electrode catalyst layer formed by the membrane forming process (3) preferably at above a boiling point of the solvent, desirably at about 150° C. or less for at least about 20 minutes or more. An object of the drying process is to remove water or solvent included in the electrode catalyst layer. The water or solvent included in the electrode catalyst layer is volatized by drying in the foregoing temperature range for a predetermined time such that the electrode catalyst layer may be sufficiently dried. The electrode catalyst layer according to the present embodiment may be obtained through the above drying process. A preliminary drying process, which is for roughly removing the solvent included in the electrode catalyst layer, as well as for forming a surface of the electrode catalyst layer, may also be performed before the above drying process.

Membrane Electrode Assembly 100

A fuel cell according to the present embodiment is composed of a plurality of single cells sandwiched between a pair of holders. The single cell includes a membrane electrode assembly (MEA) and bipolar plates (separators) arranged at both sides of the membrane electrode assembly in a thickness direction. The single cell is operated at conditions which include an operating temperature of about 100-200° C. and non-humidified air or a relative humidity of about 50% or less. The bipolar plates are formed of metal or carbonaceous materials having conductivity, etc. The bipolar plates supply oxygen and fuel to the electrode catalyst layers of the membrane electrode assemblies as well as function as a current collector by connecting to the membrane electrode assemblies.

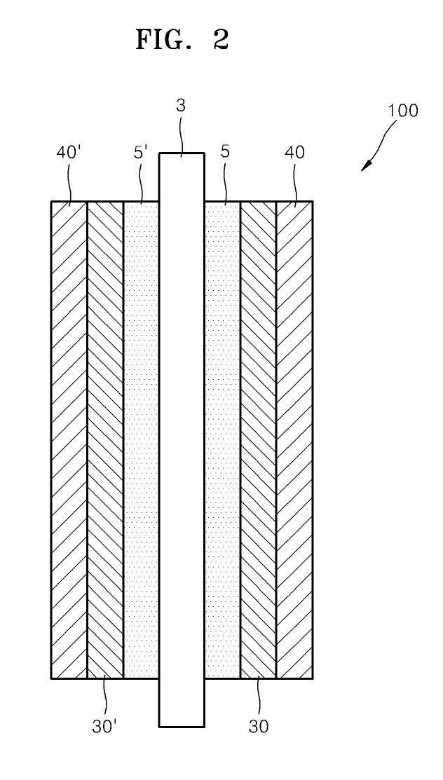

First, a membrane electrode assembly according to the present embodiment will be described with reference to FIG. 2. FIG. 2 is a cross-sectional view illustrating a structure of a membrane electrode assembly according to another embodiment of the present invention.

As shown in FIG. 2, a membrane electrode assembly 100 according to the present embodiment is composed of a polymer electrolyte membrane 3, electrode catalyst layers 5 and 5′ disposed at both sides of the polymer electrolyte membrane 3 in the thickness direction, first gas diffusion layers 30 and 30′ stacked on the electrode catalyst layers 5 and 5′, respectively, and second gas diffusion layers 40 and 40′ stacked on the first gas diffusion layers 30 and 30′, respectively. The electrode catalyst layers 5 and 5′, the first gas diffusion layers 30 and 30′, and the second gas diffusion layer 40 and 40′ constitute a pair of electrodes.

Herein, the foregoing description relating to the polymer electrolyte membrane 3 and the electrode catalyst layers 5 and 5′ may be applied as it is. Therefore, overlapping description will not be provided below.

The first gas diffusion layers 30 and 30′ and the second gas diffusion layers 40 and 40′ are composed of carbon sheets or the like, respectively, and diffuse oxygen and fuel gases, which are supplied through bipolar plates, to the entire surfaces of the electrode catalyst layers 5 and 5′.

A fuel cell including the membrane electrode assembly 100 operates at a temperature of about 100-200° C. As a fuel gas, for example, hydrogen gas is supplied to an electrode catalyst layer 5 or 5′ on one side of the polymer electrolyte membrane 3 through a bipolar plate, and as an oxidant, for example, oxygen gas is supplied to the electrode catalyst layer 5′ or 5 on the other side of the polymer electrolyte membrane 3 through the bipolar plate. Hydrogen is oxidized at one of the electrode catalyst layers 5 or 5′ to generate protons and the protons arrive at the other of the electrode catalyst layers 5′ or 5 by passage through the polymer electrolyte membrane 3. Then, electrical energy as well as water is generated by electrochemical reaction of the protons and oxygen at the other of the electrode catalyst layers 5 or 5′. Also, the hydrogen supplied as a fuel may be formed by reforming hydrocarbon or an alcohol, and the oxygen supplied as the oxidant may be supplied in the form of air.

Fuel Cell

A fuel cell according to another embodiment of the present invention will be described below. A polymer electrolyte type fuel cell according to the present embodiment includes a stack formed by alternately stacking a plurality of the membrane electrolyte assemblies 100 and the bipolar plates, current collectors for an anode and a cathode installed at both sides of the stack, and end plates respectively attached to the current collectors for an anode and a cathode by disposing insulators therebetween.

A fuel flow channel, through which the fuel flows, is installed at the anode side of the each bipolar plate, and an oxidant flow channel, through which the oxidant flows, is installed at the cathode side of the each bipolar plate. Also, instead of the bipolar plates, a fuel plate in which the fuel flow channel is installed, an oxidant plate in which the oxidant flow channel is installed, and a separator disposed between the fuel plate and the oxidant plate may be installed. Each cell having a central membrane electrode assembly functions as a single cell of the fuel cell, and electric power generated in the each cell is output externally via the current collector for an anode and the current collector for a cathode.

As described above, the doped electrode catalyst 20 according to an embodiment of the present invention may effectively impregnate phosphoric acid as a proton path in the pores of the catalyst carrier (conductive carrier). As a result, in the electrode using the foregoing doped electrode catalyst 20, improvement in power generation characteristics of an acid-doped type fuel cell may be obtained by increasing the catalyst reaction area. Also, in the acid-doped type fuel cell using the electrode according to an embodiment of the present invention, there may be a greatly reduced aging (conditioning) time for activating initial power generation.

Since the electrode for a fuel cell 1 according to an embodiment of the present invention has the electrode catalyst layer 5 in which the doped catalyst 20 and the undoped catalyst 10 are uniformly dispersed, it becomes possible to trap the acid which is leached from the polymer electrolyte membrane over time. In addition, since openings for gas diffusion in the electrode catalyst layer 5 may be maintained, deterioration of the power generation characteristics is reduced and durability is improved.

Hereinafter, the present invention will be described in more detail with reference to Examples, but the present invention is not limited to the Examples below.

### Preparation Example 1

### Preparation of Acid-Undoped Electrode Catalyst 10

A carbon carrier (BET specific surface area: about 60 m²/g) which was prepared by a partial graphitization of a commercial carbon carrier (VULCAN XC-72, Cabot Corporation), was used as a conductive carrier, and an electrode catalyst, in which a platinum-cobalt alloy (weight ratio of platinum:cobalt=10:1) was supported on the carbon carrier as catalyst particles, and was used as an undoped electrode catalyst (undoped catalyst). The supported amount of platinum in the undoped electrode catalyst was about 50 wt % based on the weight of the carbon carrier.

### Preparation Example 2

### Preparation of Acid-Doped Electrode Catalyst 20

About 5 g of the undoped electrode catalyst obtained in Preparation Example 1 was dispersed in about 100 g of a phosphoric acid aqueous solution with a concentration of about 85 wt %, and after stirring, phosphoric acid was impregnated into the pores of the carbon carrier by maintaining the mixture in a vacuum device for about 1 hour. Subsequently, the mixture was heat treated at 150° C. Thereafter, after washing and filtering the electrode catalyst in which the carbon carrier was impregnated with phosphoric acid, an acid-impregnated catalyst (doped catalyst) was obtained by drying.

In order to measure the amount of phosphoric acid impregnated in the doped catalyst thus obtained, quantitative analysis on the impregnated phosphoric acid was performed using an inductively coupled plasma-atomic emission spectrometry method. An analyzing instrument used was an inductively coupled plasma-atomic emission spectrometer (SPS-1700HVR) of SII Nano Technology Inc.

According to the measured results, the amount of phosphoric acid impregnated in the doped catalyst was about 0.73 wt % based on the weight of the carbon carrier.

### Example 1

An electrode for a fuel cell was prepared using the doped and undoped catalysts prepared in the Preparation Examples. First, about 0.8 g of the doped catalyst and about 0.2 g of the undoped catalyst (that is, the weight ratio of the doped catalyst to the undoped catalyst=80:20) were added into a solution having about 5 wt % of PVdF, in which about 1.0 g of polyvinylidenefluoride (PVdF) binder resin was dissolved in about 19 g of N,N-dimethylformamide (DMF). An electrode slurry was prepared by dispersing the resultant mixture with a magnetic stirrer for about 10 minutes.

This electrode slurry was coated on a gas diffusion layer (GDL 34BC of SGL Carbon SE), to which a microporous layer was attached, using a doctor blade. An electrode was prepared by forming an electrode catalyst layer 5 by preliminarily drying at about 60° C. for about 20 minutes and then drying at about 150° C. for about 30 minutes.

A dried polybenzimidazole (PBI) membrane (thickness of about 35 μm) was obtained by casting a N-methyl-2-pyrrolidone (NMP) solution of PBI, in which about 10 wt % of PBI (intrinsic viscosity of about 0.7-0.9 dL/g when measured by dissolving in sulfuric acid with the concentration of about 30 wt %) was dissolved. Then, a phosphoric acid-doped PBI membrane, which was swollen by phosphoric acid, was obtained as a polymer electrolyte membrane 3 by immersing the dried PBI membrane in a phosphoric acid aqueous solution of about 85 wt % heated at about 60° C. for about 2 hours. The thickness of the PBI membrane after swelling was about 100 μm, and the doping amount of phosphoric acid was about 350 wt % based on 100 wt % of the PBI membrane.

The electrode thus prepared was cut into squares with a side of 5 cm to be used as an anode and a cathode. A membrane electrode assembly 100, as shown in FIG. 2, was prepared by sandwiching the polymer electrolyte membrane, which was cut into a square with a side of 7 cm, between the catalyst layers 5 or 5′ of the anode and cathode.

### Comparative Example 1

Except for using about 1.0 g of the undoped catalyst 10 (100 wt % of the undoped catalyst) obtained in Preparation Example 1 without using the doped catalyst, the electrode 1 and the membrane electrode assembly 100 were prepared using the same method as described in Example 1.

### Comparative Example 2

Except for using about 1.0 g of the doped catalyst (100 wt % of the doped catalyst) obtained in Preparation Example 2 without using the doped catalyst, the electrode and membrane electrode assembly 100 were prepared using the same method as described in Example 1.

<Preparation of a Fuel Cell>

After installing a gasket (thickness of about 200° C.) formed of polytetrafluoroethylene (TEFLON-PTFE®, DuPont) around the electrode of the membrane electrode assembly 100, the structure was sandwiched between carbon separators having gas flow channels. The foregoing structure was again sandwiched between current collectors. After sandwiching both ends of the foregoing structure by end plates formed of stainless steel, a test cell was prepared by firmly tightening bolts with a torque wrench to a tightening pressure of about 5×10⁵ Pa.

<Test for Power Generation Characteristics of a Fuel Cell>

While nitrogen was fed into the test cell to purge air or oxygen, the temperature was increased to about 150° C. Pure hydrogen gas, as a fuel gas, at the anode and air, as an oxidant, at the cathode were directly introduced (that is, not through a humidifier and in a non-humidified condition) through mass flowmeters controlling flows from gas containers that control hydrogen and oxygen gas utilization ratios to be about 80% and about 50%, respectively. In order to measure the polarization characteristics of power generation and continuous power generation characteristics, constant current operation at 0.3 A/cm² was performed using an electronic load device (ELZ-303, KEISOKU GIKEN) for measuring the continuous power generation characteristics, as well as changes in power generation characteristics over time.

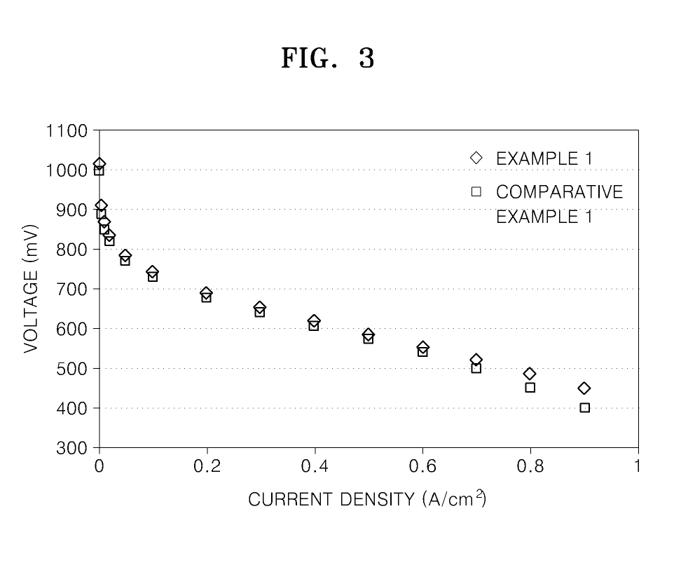

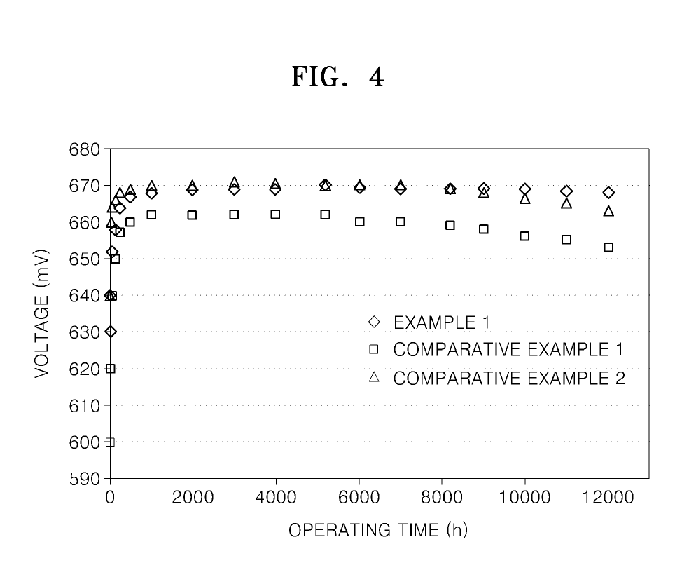

FIG. 3 is a graph of current-voltage characteristics showing power generation characteristics of a test cell using the membrane electrode assemblies of Example 1 and Comparative Example 1, and FIG. 4 is a graph showing changes in power generation characteristics of a test cell over time using the membrane electrode assemblies of Example 1, Comparative Example 1, and Comparative Example 2.

As shown in FIG. 3, the MEA (Δ) using the electrode of Example 1 exhibits better power generation characteristics than the MEA (□) using the undoped electrode of Comparative Example 1. It is estimated that since phosphoric acid is uniformly distributed in the catalyst layer by the advance phosphoric acid treatment on the catalyst, effective proton paths are formed, and improvement of characteristics is achieved due to these paths.

As shown in FIG. 4, the MEA (⋄) using the electrode for a fuel cell prepared in Example 1 exhibits voltage values higher than the MEA (Δ) using the undoped electrode prepared in Comparative Example 1. The initial startup (conditioning) time was reduced from about 250 hours (Comparative Example 1) to about 50 hours (Example 1). That is, although it is not shown clearly in FIG. 4, the time required for increasing voltage up to about 660 mV was about 250 hours in the case of Comparative Example 1 and was about 50 hours in the case of Example 1. This shows that the power generation characteristics of the MEA 100 prepared in Example 1 are improved as compared to the MEA prepared in Comparative Example 1. Also, this shows that the initial startup (conditioning) time of the MEA prepared in Example 1 is reduced to about ⅕ of the initial startup (conditioning) time for the MEA prepared in Comparative Example 1.

When comparing the MEA (⋄) prepared in Example 1 and the MEA (Δ) prepared with the electrode (Comparative Example 2) using 100 wt % of the doped catalyst which has been subjected to the phosphoric acid treatment process, it is confirmed that although the initial startup (conditioning) of power generation characteristics is slightly poorer (longer) with Example 1, the power generation characteristics over time are maintained for a longer period of time in the case of the MEA (⋄) prepared in Example 1.

Thus, since an acid is uniformly distributed in the catalyst layer by performing the phosphoric acid treatment process on the catalyst in advance, effective proton paths are formed such that improvement of characteristics may be achieved. Also, since the optimum amount of acid is controlled in the catalyst layer 5 from the beginning, reduction of the conditioning time becomes possible and difference in characteristics may be achieved.

Although there are limitations in that the acid doped in the polymer electrolyte membrane is leached into the catalyst layer over time and, thereafter, is discharged to the outside of the MEA, the discharging of the acid may be prevented by trapping the acid in the MEA even in this case because the electrode for a fuel cell according to Example 1 has a tolerance limit for allowing the conductive carriers of the undoped catalyst to impregnate the acid as clearly shown in FIG. 4. Since it also becomes possible to have a combined function that does not damage openings for gas diffusion, it is estimated that improvement of durability may be promoted in comparison to the other MEA structures.

As described above, in the electrode for a fuel cell using the catalyst obtained by the phosphoric acid impregnation treatment process of the present invention, distribution of phosphoric acid is uniform and the activation area of the catalyst (uniform distribution of acid in the pores of the carbon carriers) is increased, thereby improving power generation characteristics and rapidly reaching an equilibrium voltage at the initial stage of power generation. By using the electrode prepared by mixing the catalyst obtained from the phosphoric acid impregnation treatment process and the untreated catalyst, phosphoric acid leached from the membrane may be trapped in the carbon carriers of the untreated catalyst. Therefore, durability may be improved.

As described above, according to an electrode for a fuel cell of the present invention, and a membrane electrode assembly and a fuel cell employing the electrode for a fuel cell, the power generation characteristics may be stably maintained from the initial stage of operation by using a catalyst which has been subjected to treatment in which acid is uniformly distributed by allowing the acid to be absorbed in the catalyst particles in advance when forming an electrode catalyst layer.

While the present invention has been particularly shown and described with reference to exemplary embodiments thereof, it will be understood by those of ordinary skill in the art that various changes in form and details may be made therein without departing from the spirit and scope of the present invention as defined by the following claims.

For example, in the foregoing embodiment, it has been described that the doped catalyst and the undoped catalyst are uniformly dispersed in the electrode catalyst layer. However, effects according to an embodiment of the present invention may be achieved to some extent even when the doped catalyst 20 and the undoped catalyst 10 are not uniformly dispersed in the electrode catalyst layer 5, although performance is inferior to the case of uniform dispersion. Also, the electrode catalyst layer 5 may have a stack structure which is composed of a first catalyst layer formed of undoped catalyst 10 positioned at a side of the polymer electrolyte membrane 3 and a second catalyst layer formed of doped catalyst 20 stacked on the first catalyst layer.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electrode for a fuel cell comprising an electrode catalyst layer,
wherein the electrode catalyst layer comprises an electrode catalyst including a conductive carrier and catalyst particles supported on the conductive carrier, and
the electrode catalyst includes an acid impregnated electrode catalyst in which the conductive carrier is impregnated with an acid component having proton conductivity and a non-impregnated electrode catalyst in which the conductive carrier is not impregnated with the acid component.

2. The electrode of claim 1, wherein the electrode catalyst layer has a mixing ratio in which the ratio of the weight of the acid impregnated electrode catalyst to the weight of the non-impregnated electrode catalyst ranges from about 5:95 to about 95:5, during the forming of the electrode catalyst layer.

3. The electrode of claim 1, wherein the conductive carrier is a carbonaceous material.

4. The electrode of claim 1, wherein the catalyst particles comprise one or more metals or alloys selected from the group consisting of platinum (Pt), gold (Au), palladium (Pd), rhodium (Rh), iridium (Ir), ruthenium (Ru), cobalt (Co), iron (Fe), lead (Pb), manganese (Mn), chromium (Cr), gallium (Ga), tin (Sn), molybdenum (Mo), and vanadium (V).

5. The electrode of claim 1, wherein the acid component is an aqueous solution of at least one or more acids selected from the group consisting of phosphoric acid, phosphoric acid derivatives, phosphonic acid, phosphonic acid derivatives, phosphinic acid, phosphinic acid derivatives, sulfuric acid, sulfuric acid derivatives, sulfonic acid, and sulfonic acid derivatives.

6. The electrode of claim 1, wherein the electrode catalyst layer further comprises one or more hydrophobic binder resins selected from the group consisting of polytetrafluoroethylene (PTFE), poly(vinylidene fluoride) (PVDF), tetrafluoroethylene-hexafluoropropylene copolymer, polychlorotrifluoroethylene (PCTFE), tetrafluoroethylene-ethylene copolymer (ETFE), tetrafluoroethylene-perfluoroalkylvinyl ether copolymer, styrene butadiene rubber (SBR), and polyurethane.

7. A method of preparing an electrode for a fuel cell according to claim 1, the method comprising:
coating a composition for an electrode catalyst layer on a substrate, the composition comprising an acid impregnated electrode catalyst in which a conductive carrier is impregnated with an acid component having proton conductivity and a non-impregnated electrode catalyst in which the conductive carrier is not impregnated with the acid component; and
drying the coated composition for an electrode catalyst layer to form an electrode catalyst layer.

8. The method of claim 7, wherein the composition for the electrode catalyst layer has a mixing ratio in which the ratio of the weight of the acid impregnated electrode catalyst to the weight of the non-impregnated electrode catalyst ranges from about 5:95 to about 95:5.

9. The method of claim 7, wherein the acid impregnated electrode catalyst is formed by a method comprising dispersing the acid non-impregnated electrode catalyst in the acid component and performing a heat treatment.

10. The method of claim 9, wherein the heat treatment is performed at a temperature of about 100° C. to about 150° C.

11. The method of claim 7, wherein the conductive carrier is a carbonaceous material.

12. The method of claim 8, wherein the catalyst particles comprise one or more metals or alloys selected from the group consisting of platinum (Pt), gold (Au), palladium (Pd), rhodium (Rh), iridium (Ir), ruthenium (Ru), cobalt (Co), iron (Fe), lead (Pb), manganese (Mn), chromium (Cr), gallium (Ga), tin (Sn), molybdenum (Mo), and vanadium (V).

13. The method of claim 7, wherein the acid component is at least one or more acids selected from the group consisting of phosphoric acid, phosphoric acid derivatives, phosphonic acid, phosphonic acid derivatives, phosphinic acid, phosphinic acid derivatives, sulfuric acid, sulfuric acid derivatives, sulfonic acid, and sulfonic acid derivatives.

14. The method of claim 7, wherein the electrode catalyst layer further comprises one or more hydrophobic binder resins selected from the group consisting of polytetrafluoroethylene (PTFE), poly(vinylidene fluoride) (PVDF), tetrafluoroethylene-hexafluoropropylene copolymer, polychlorotrifluoroethylene (PCTFE), tetrafluoroethylene-ethylene copolymer (ETFE), tetrafluoroethylene-perfluoroalkylvinyl ether copolymer, styrene butadiene rubber (SBR), and polyurethane.

15. The method of claim 9, wherein the acid component is an aqueous solution of at least one or more acids selected from the group consisting of phosphoric acid, phosphoric acid derivatives, phosphonic acid, phosphonic acid derivatives, phosphinic acid, phosphinic acid derivatives, sulfuric acid, sulfuric acid derivatives, sulfonic acid, and sulfonic acid derivatives.

16. A membrane electrode assembly (MEA) for a fuel cell, comprising:
a cathode and an anode disposed to face each other; and
a solid electrolyte membrane disposed between the cathode and the anode,
wherein the solid electrolyte membrane comprises an acid-doped basic polymer, and at least one of the cathode and the anode is the electrode for a fuel cell according to claim 1.

17. A fuel cell comprising a membrane electrode assembly including an electrode for a fuel cell according to claim 1.
